(19) United States
(12) Patent Application Publication
(10) Pub. No.: US 2017/0068906 A1
(43) Pub. Date: Mar. 9, 2017

(54) Determining the Destination of a Communication

(71) Applicant: Microsoft Technology Licensing, LLC, Redmond, WA (US)

(72) Inventors: Jacek A. Korycki, San Jose, CA (US); David L. Racz, Palo Alto, CA (US)

(21) Appl. No.: 14/954,282

(22) Filed: Nov. 30, 2015

Related U.S. Application Data
(63) Continuation-in-part of application No. 14/849,267, filed on Sep. 9, 2015.

(51) Int. Cl. G06N 99/00; H04L 12/58; G06N 7/00; H04L 29/06

(52) U.S. Cl. CPC G06N 99/005; H04L 65/1069; H04L 65/403; H04L 51/04; G06N 7/005

(57) ABSTRACT

Training data is collected describing multiple past communications over a computer-implemented communication service. For each of the past communications, the training data set comprises a record of a respective recipient of the respective communication, and a record of respective feature vector of the respective communication, wherein the recipient is defined in terms of an identity of in individual person, and wherein the feature vector comprises a respective set of values of a plurality of parameters associated with the respective communication. The training data is used to train a machine learning algorithm. By applying the machine learning algorithm to the feature vector of a respective subsequent message, to be sent by a sending user over the computer-implemented communication service, a prediction is generated regarding one or more potential recipients of the subsequent message.

### RELATED APPLICATION

This application is a continuation-in-part of and claims priority at least under 35 U.S.C. §120 to co-pending U.S. patent application Ser. No. 14/849,267, titled “Determining the Destination of a Communication” and filed on Sep. 9, 2015, the entire disclosure of which is incorporated in its entirety by reference herein.

### BACKGROUND

People have increasingly large numbers of contacts originating from a variety of communication systems, collaboration tools, and online directories. For example, contacts are often stored in Outlook, Skype, Active Directory, Facebook, mobile phone address books, and a variety of email services. The management and curation of these contact lists has become a significant pain point for users. Over time, these lists tend to grow, making the search and discovery of desired contacts increasingly difficult.

There are a few common solutions to this problem. First, users often create contact “groups” containing smaller sets of people that are more frequently contacted. These groups are often related to categories like “family” or “work”, or in the work setting by department, team, or job role. The creation and management of such groups are tedious tasks as the number of groups, and the number of people within the groups, tend to grow and become outdated as communication patterns shift.

Secondly, devices often provide a manually or automatically created list of “favorites” that contain the most recently, and/or most frequently used contacts. Similarly, on mobile phones, users often use the “Recents” lists of calls and messages to find the desired contact. This solution works well for the small number of contacts that are regularly contacted, but fails to help for the large number of contacts that are individually contacted less frequently, but together account for a significant number of communication actions.

Finally, some services are beginning to use some communication context to suggest contacts. For example, Gmail has experimented with a “Suggest Additional Recipients” feature that can recommend additional email recipients that are predicted to be likely based on the co-occurrence of the recipients in the user's email history. Currently, these systems consider a small set of historical context to make the prediction, and are limited to specific communication channels, like email, text messages, or phone calls.

### SUMMARY

The following addresses the problem of communication and collaboration prediction in communication systems and systems supporting collaborative work. The goal is to predict which contacts a user is most likely to communicate or collaborate with given the context of the user and the history of interaction between users. For example, embodiments provide an estimate of the probability that a user A will call, send an instant message, invite to a meeting, some other user B, during some specific time interval. In the following, this task (or similar) may generally be referred to as collaboration prediction.

According to one aspect disclosed herein, there is provided a method comprising collecting a training data set describing multiple past communications previously conducted over a computer-implemented communication service. For each respective one of the past communications, the training data set comprises a record of a respective one or more recipients of the respective communication, and a record of a respective feature vector of the respective communication. Each of the recipients is defined in terms of an identity of an individual person with whom the respective communication was conducted. The feature vector comprises a respective set of values of a plurality of parameters associated with the conducting of the respective communication. The method then further comprises: inputting the training data into a machine learning algorithm in order to train the machine learning algorithm; and by applying the machine learning algorithm to a further feature vector comprising a respective set of values of said parameters for a respective message to be sent by a sending user over the computer-implemented communication service, generating a prediction regarding one or more potential recipients of the message (each of the one or more potential recipients also being defied in terms of an identity of individual person).

Embodiments deal with scenarios where the message does not itself comprise the user content of the collaboration (or at least not the main content), but rather is an invitation to a communication session that is yet to take place at the time of sending said message. E.g. the communication session may be an in-person meeting, and each of some or all of the past communications may be a past in-person meeting. And/or, the communication session may be a voice or video call, and each of some or all of the past communications may be a past voice or video call. And/or, the communication session may be an IM chat session, each of some or all of the past communications is a past IM chat session. In embodiments, the method of any preceding claim, wherein each of the feature vectors contains no parameters based on any user-generated content of the message.

In such cases, parameters other than those based on the content of the message are needed to make a prediction. For example, the parameters of each of the feature vectors comprise any one or more of: an identifier of the sending user, a time of conducting the respective message, an amount of previous activity between the sending user and the respective recipient, a measure of how recently the sending user has communicated with the more respective recipient, and/or a relationship between the sending user and the respective recipient.

In some embodiment, the parameters of each of the feature vectors comprise one or more parameters based on a user-generated title or subject line of the past communications. In such embodiments, each of the feature vectors may comprises no parameters based on any user-generated content other than the title or subject line. Again therefore other parameters are required, such as those mentioned above.

In further embodiments, the identities of the recipients in said record are recorded in a transformed (e.g. hashed) form in order to obscure the identities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a communication system,

FIG. 2 is a schematic block diagram of a user terminal and server,

FIG. 3 is a schematic illustration of a user interface,

FIG. 4 is a schematic block diagram of a machine learning pipeline,

FIG. 5 is a mock-up of the front-end of a client application,

FIG. 6 is another mock-up of a client application front-end,

FIG. 7 is another mock-up of a client application front-end,

FIG. 8 is another mock-up of a client application front-end, and

FIG. 9 is another mock-up of a client application front-end.

### DETAILED DESCRIPTION OF EMBODIMENTS

Document or message classification is known and has many uses. For example, in the news industry, document classification is a known problem where a new document is supposed to be assigned to one of the fixed categories, such as “domestic”, “international”, “about China”, “sports” etc. In some cases, such classification is assisted based on machine learning techniques, such as Naïve Bayes classifiers.

In email, automatic spam detection and filtering is used based on binary document classification of an email as spam or not spam. Naïve Bayes is a typical algorithm for this application as well.

However, it has not previously been considered that an automated approach could be taken to predicting the destination of a message (also referred to herein as a “channel”). For instance, the above approaches do not capture the richness of context in group communication systems, which include factors such as temporal dynamics (various topics discussed in the same channel over time), and social dynamics (the changing audience of the messages). Such areas are exploited herein, by selecting the proper features to represent these factors, and by defining a complementary training procedure. The output of the process may then suggest ways to utilize the results of classification to enhance the user experience, or may provide an alert of a possible mistake in directing the message to a selected channel.

According to one aspect disclosed herein, there is provided a method comprising collecting a training data set describing multiple past messages previously sent over a computer-implemented communication service. For each respective one of the past messages, the training data set comprises a record of a respective channel of the respective message, and a record of respective feature vector of the respective message, wherein the channel corresponds to a respective one or more recipients to which the respective message was sent, and wherein the feature vector comprises a respective set of values of a plurality of parameters associated with the sending of the respective message. The method further comprises inputting the training data into a machine learning algorithm in order to train the machine learning algorithm. By applying the machine learning algorithm to a further feature vector comprising a respective set of values of said parameters for a respective subsequent message, to be sent by a sending user over the computer-implemented communication service, the method then comprises generating a prediction regarding one or more potential recipients of the subsequent message.

A “channel” is a term used herein to refer to any definition directly or indirectly mapping to one or more recipients, e.g. an individual name or address of one or more recipients, or a group such as a chat room or forum used by the recipients, or a tag to which the recipients subscribe.

The parameters of each of the feature vectors may comprise one or more parameters based on the content of the respective message (i.e. the material in the payload of the message composed by the sending user), such as: a title of the respective message, one or more keywords in the respective message, and/or a measure of similarity between the respective message and one or more earlier messages in the training data set sent to the respective channel (by the sending user or by all users sending to the respective channel). Alternatively or additionally, the parameters may comprise other examples such as: an identifier of the sending user, a time of sending the respective message, an amount of previous activity of the sending user on the respective channel, and/or a relationship between the sending user and the respective one or more recipients (such as a social media connection).

Thus the present disclosure addresses the issue of accurately directing messages to channels in communication systems such as IM (instant messaging) chat systems, video messaging systems or email systems. The disclosure provides a machine learned classification method that can automatically learn based on existing history data in the system and be used at prediction time to compute probability of assigning a new message to one or more messaging channels. This information may be used to provide suggestions to the author about where (or where else) he/she should target the message after it has been composed. Alternatively, the predicted probability information may be used to compare against the target channel choices made by the author, and if sufficiently different, the may be used to prevent a mistake by alerting the author prior to sending the message, and giving him/her a chance to withdraw the message thus saving himself/herself undesirable consequences such as embarrassment, confusion of others, or leakage of sensitive information.

The following describes a scheme employing machine learned classification in order to enhance routing of newly composed messages to receiving users in text and document communication and collaboration systems (where “routing” herein refers to determining the destination of the message). IM chat messaging is one prominent example of such systems. In embodiments the destination may be defined in terms of an individual name or address of one or more recipient users, but alternatively the following also encompasses chat-room based messaging or the like, where the destination is defined as a particular chat room, forum or other group; or tag based messaging, wherein the destination is defined by one or more tags assigned by the author. Accordingly the concept of message destination is generalized herein as a “channel”.

In embodiments, the output of the machine learning is used to enhance the existing routing assigned “manually” by an author, as a list of channels, with one computed automatically by the system. This can help prevent mistakes when a message is about to be sent to a wrong or inappropriate place. In further embodiments, the output of the machine learning may be used to generate suggestions as to where the message might also be sent, or even to make fully automated routing without user specification or approval.

The following also specifies techniques for actually deriving such automated routing (list of recommended channels). In embodiments this is performed by defining a machine learning binary classification approach. This approach yields a prediction function that computes a probability value for each candidate channel. The most probable channels can then be compared with the channels selected by the user “by hand”, and act when the two lists diverge.

Furthermore, in embodiments the process may comprise the following components:

a scheme for defining a large training set of examples from existing data (history of communication) recorded by the communication system;

a scheme for defining a comprehensive set of features that describe quantitatively the full information context of the routing decision, including the message itself, the history of prior messages per channel, the author, the audience and time of posting; and

a scheme for accurate representation of the relationship of the new message to the history of prior messages in the channel that include the temporal dynamics, i.e. by combining similarities between the message and multiple various fragments of the history spread across time.

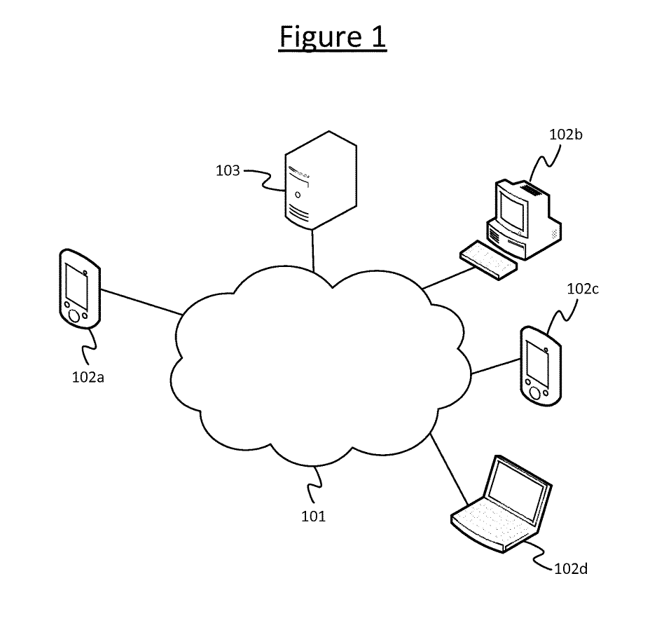

Some example implementations will now be discussed in more detail with reference to FIGS. 1 to 3.

FIG. 1 shows an example of a communication system in accordance with embodiments of the present disclosure. The system comprises a network 101, preferably a wide area internetwork such as the Internet; and a plurality of user terminals 102a-d each connected to the network 101 by a respective wired or wireless connection; and a optionally a server 103 also connected to the network 101. The following may be described in terms of the network 101 being the Internet, but it will be appreciated this is not necessarily limiting to all possible embodiments, e.g. alternatively or additionally the network 101 may comprise a company intranet or mobile a cellular network.

Each of the user terminals 102 may take any suitable form such as a smartphone, tablet, laptop or desktop computer (and the different user terminals 102 need not necessarily be the same type). Each of at least some of the user terminals 102a-d is installed with a respective instance of a communication client application. For example, the application may be an IM chat client by which the respective users of two or more of the user terminals can exchange textual message over the Internet, or the application may be a video messaging application by which the respective users of two or more of the terminals 102a-d can establish a video messaging session between them over the Internet 101, and via said session exchange short video clips in a similar manner to the way users exchange typed textual messages in an IM chat session (and in embodiments the video messaging session also enables the users to include typed messages as in IM chat). As another example, the client application may be an email client. The following may be described in terms of an IM chat session or the like, but it will be appreciated this is not necessarily limiting.

In embodiments, the messages referred to herein may be sent between user terminals 102 via a server 103, operated by a provider of the messaging service, typically also being a provider of the communication client application. Alternatively however, the message may be sent directly over the Internet 101 without travelling via any server, based on peer-to-peer (P2P) techniques. The following may be described in terms of a server based implementation, but it will be appreciated this is not necessarily limiting to all embodiments. Note also that where a server is involved, this refers to a logical entity being implemented on one or more physical server units at one or more geographical sites.

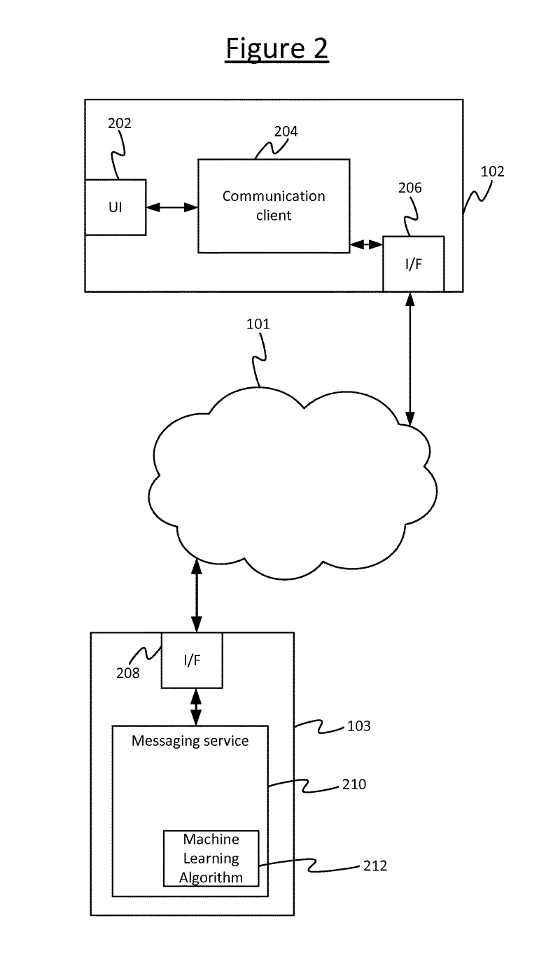

FIG. 2 shows a user terminal 102 in accordance with embodiments. At least a first of the user terminals 102a is configured in accordance with FIG. 2, and in embodiments one or more others 102b-d may also be configured this way. For purpose of illustration the following will be described in terms of the first user terminal 102a being a sending (near-end) user terminal sending a message to one or more other, receiving (far-end) terminals 102b-d. However, it will be appreciated that in embodiments the other user terminal(s) 102b-d can also send message to be received by the first user terminal 102a and/or others in a similar manner.

The user terminal 102a comprises a user interface 202, network interface 206, and a communication client application 204 such as an IM client, video messaging client or email client. The communication client application 204 is operatively coupled to the user interface 202 and network interface 206. The user interface comprise and suitable means for enabling the sending user to compose a message and specify a definition of a destination for the message (or “channel”, i.e. any information directly or indirectly defining one or more recipient users of other terminals 102b-d). The sending user is there by able to input this information to the client application 204. For example the user interface 206 may comprise a touch-screen, or any screen plus mechanical keyboard and/or mouse. The network interface 206 provides means by which the client application can communicate with the other user terminals 12b-d and the server 103 for the purpose of sending the message to the recipient(s) and also any other of the communications disclosed herein. For example the network interface may comprise a wired or wireless interface, e.g. a mobile cellular modem, or a local wireless interface using a local wireless access technology such as a Wi-Fi network to connect to a wireless router in the home or office (which connects onwards to the Internet 108).

The server 103 comprises a messaging service 210 and a network interface 208, the messaging service being operatively coupled to the network interface 208. The messaging service 210 may for example be an IM service, video messaging service or email service. Again the network interface 208 may take the form of any suitable wired or wireless interface for enabling the messaging service 210 to communicate with the user terminals 102a-d for the purpose of communicating the users' messages and performing any others of the communications disclosed herein. Amongst various other components used to implement the messaging (as will be familiar to a person skilled in the art), the messaging service 210 also comprises a machine learning algorithm 212. Alternatively the machine learning algorithm 212 could be implemented at the sending user terminal 102a. The following will be described in terms of a server-based implementation, but it will be appreciated this is not limiting to all possible embodiments.

In operation, the sending user composes messages via the user interface 202 (so the sending user is the author), and in association with each message also uses the user interface 202 to input some information defining a respective destination of the message, i.e. its audience (where the audience can be one or more recipient users). This information may comprise an individual name (e.g. given name or username) or address (e.g. email address or network address) of a single recipient, or an individual name or address for each of multiple recipients, or an identifier of a group (e.g. of a chat session, chat room or forum). Or as another example, the information defining the destination could take the form of one or more tags specified by the sending user, e.g. where these tags indicate something about the topic of the message. In this case, the tag(s) can define a destination in that the messaging service 210 may enable other users to subscribe to a certain tag or combination of tags. Whenever a message is posted to the messaging service 210 by the sending user citing a tag or tags, then the messaging service automatically pushes the message to the users who have subscribed to that tag or combination of tags.

As mentioned, the term used herein as an umbrella term to cover all these possibilities is a “channel”. Note that in the case where the channel is a group such as chat room, the sender does not necessarily specify the individual names or addresses but rather just sends the message to the group generally based on an identifier of the group. Also, the membership of the group may change over time, and indeed the identity of the particular users in the group is not necessarily relevant in determining if an appropriate destination for the message. Similar comments apply in the case where the channel is defined in terms of one or more tags—the sender does not necessarily know or care who the particular recipients are. Hence it may be said that the channel indirectly defines the recipients, as opposed to directly in the case of individual names or addresses.

Thus the present disclosure applies to a wide array of communication systems where a user composes a message (e.g. text or document) and submits it to the communication system for delivery to other users who may then view it, providing extra information to guide the routing of the message to the receiving users. This routing information describes the list of recipients for the message, i.e. the intended audience. This general description includes (but is not limited to) the following cases:

Chat rooms. Here the routing information consists of an identifier of a chat room to which the message is to be posted. The audience are the members of the same chat room. Skype chat is a prominent example of such as a system.

Tags. Here the routing information is a set of tags assigned by the author that reflect the key concepts related to in the message. The audience consists of the users who subscribe to any of the tags. This form of communication is characteristic of blogging.

The teachings herein apply to each such form of communication, and so to describe it a common way, the concept of a collaboration channel, or channel for short, is introduced. It denotes the target audience of the message. In what follows, the user addresses the message to a number of channels. The system fans the message out to all the users who subscribe to any of these channels. A system where only one channel can be used per message boils down to a group chat system. If multiple channels are allowed, this is covered by the tag based distribution.

Based on the channel specified by the sending user, the communication client 204 uses the network interface 206 to transmit the message over the internet 108 to the user terminal(s) 102b-d of the respective one or more recipient users. In embodiments, the messages are sent via the server 103, i.e. the messaging service 210 actually receives the message from the sending user terminal 102a and forwards it on to the recipient user terminal(s) 102b-d. Each time a message is sent in this manner, the channel is recorded by the messaging service 210, along with values of a set of parameters of the message (a “feature vector”). Over time the messaging service thus builds up a large list recording the destination (channel) and parameters (feature vector) of many past messages sent by the sending user. This list is input as training data into the machine learning algorithm 212, in order to train it as to what feature vector values typically correspond to what channel (what destination), thus enabling it to make predictions as to what the destination of a future message should be given knowledge of its feature vector. Over time as further messages are sent, these are added dynamically to the training set to refine the training and therefore improve the quality of the prediction.

Preferably, when the client applications on other sending user terminals 102 send messages using the messaging service 210, the same information is also captured in a similar into the training data used to train the machine learning algorithm. Hence in embodiments, the predictions may be based on the past messages of multiple sending users on a given channel (e.g. multiple users sending messages to a given chat room or with a given tag). Alternatively, a separate model may be trained for each sending user using only information on the past messages of that user, and so the prediction may be made specifically based on the sending user's own past use of the service.

Examples will be discussed in more detail below, but to give an idea, examples of the parameters making up the feature vector include parameters based on content of the respective message, such as a title of the respective message, one or more keywords in the respective message, and/or a measure of similarity between the respective message and one or more earlier messages in the history of the channel (metrics measuring the similarity between two strings are in themselves known in the art). Other examples include: an identifier of the sending user; a time of sending the respective message (e.g. time of day, day of the week, and/or month of the year); an amount of previous activity of the sending user on the respective channel (e.g. a number or frequency of the previous messages sent by the sending user to the respective channel), and/or a relationship between the sending user and the respective one or more recipients (e.g. whether or not connected on a particular social or business network site, and/or a category of the connection or relationship).

Note: in alternative, P2P based approach the message is not sent via the server 103, but rather the messaging service 210 on the service only provides one or more supporting functions such as address look-up, storing of contact lists, and/or storing of user profiles. In such cases, whenever the communication client application 204 sends a message, it reports the channel and feature vector to the messaging service 210 to be logged in the training data set. Another possibility is that the machine learning algorithm 212 is hosted on a server of a third-party rather than the provider of the messaging service 210. In this case, either the communication client on the sending terminal 102a or the messaging service 210 may report the relevant information (channel and feature vector) to the machine learning algorithm. Or wherever the algorithm is implemented, it is even possible that the receiving terminal 102b-102d reports the information. As yet another possibility, the machine learning algorithm 212 may be implemented on the sending user terminal 102a itself.

Wherever implemented, the result of the machine learning algorithm may be used in a number of ways. For instance in embodiments, the one or more potential recipients are one or more target recipients manually selected the sending user prior to sending the subsequent message. In this case, the generating of the prediction may comprise determining an estimated probability that each of the target recipients is intended by the sending user, and generating a warning to the sending user if any of the estimated probabilities is below a threshold.

Alternatively, the one or more potential recipients are one or more suggested recipients. In this case the generating of the prediction by the machine learning algorithm 212 comprises generating the suggested recipients and outputting them to the sending user prior to the sending user entering any target recipients for said subsequent message.

As another alternative, the one or more potential recipients are one or more automatically-applied recipients. In this case the generating of the prediction by the machine learning algorithm 212 comprises generating the automatically-applied recipients and sending the subsequent message to them without the sending user entering any target recipients for said subsequent message—i.e. a completely automated selection of the message destination.

Typically, users themselves determine the right channels for the message. Using the above functionality however, this adds an automated way for determining the proper channels which can be combined with the user's decision in a variety of ways, such as follows.

The system may provide information about a possible mistake before the message is processed. Here the user selects the channels, but in the background the system determines the most relevant channels as well. The system compares both sets of channels looking for sufficiently big difference. If it sees one, perhaps the user made a mistake? This situation sometimes arises in chat systems: for example, a user composes an informal message for a social chat and mistakenly posts that to a formal chat with managers and customers, just because he/she assumed the social chat was open in the chat client. This may be a source of embarrassment, confusion, or leakage of sensitive information to inappropriate audience.

The user may seeks advice from the system. It can be a case of starting from scratch; “whom should I address it to”? Or the user might have already selected some channels, but seeks hints of any other channels that might be appropriate. Either way, the user takes the advice or not, he/she is ultimately in charge of selecting the channels.

Fully automated routing. User merely composes messages and the system delivers to the audience of its own choosing.

To realize the partial or full automation of routing such a set out above, the process disclosed herein applies a framework of machine learned classification. Classification is about assigning one or more classes to each object in a collection. In embodiments of the present case, the object is the full context of the decision which includes a message, its author and the state of the channel at the time of posting, which in turn includes messages routed via the channel so far, the current channel audience/subscribers, then time of day, the activity state of the user, etc. The class is the channel that the algorithm 212 aims to assign to this context object. An alternative way of defining the problem is in terms of binary classification, where the object being classified is the full context of the posting together with the channel, and the binary decision is “post” versus “do not post” (or “send” versus “do not send”).

More specifically, a probabilistic approach is used, where the classification produces an estimate of a probability of such a channel assignment. It is a measure of confidence that one ought to assign the message to that channel, given all the context information.

If given a new message, the system provides the list of probabilities for every eligible channel (a candidate), then it is possible to use that information to realize the functionality listed above. For a mistake alert, the algorithm 212 would compare the probability of the selected channel against the maximum probability across all channels. If the difference is sufficiently big, it has grounds for suspecting a mistake, and can alert the user (via the client 204) before the message is submitted. Moreover it can also indicate the channel that he/she might have meant. For the suggestion use case, the algorithm 212 can select one or a few channels having the top probability (in embodiments subject to some minimum threshold).

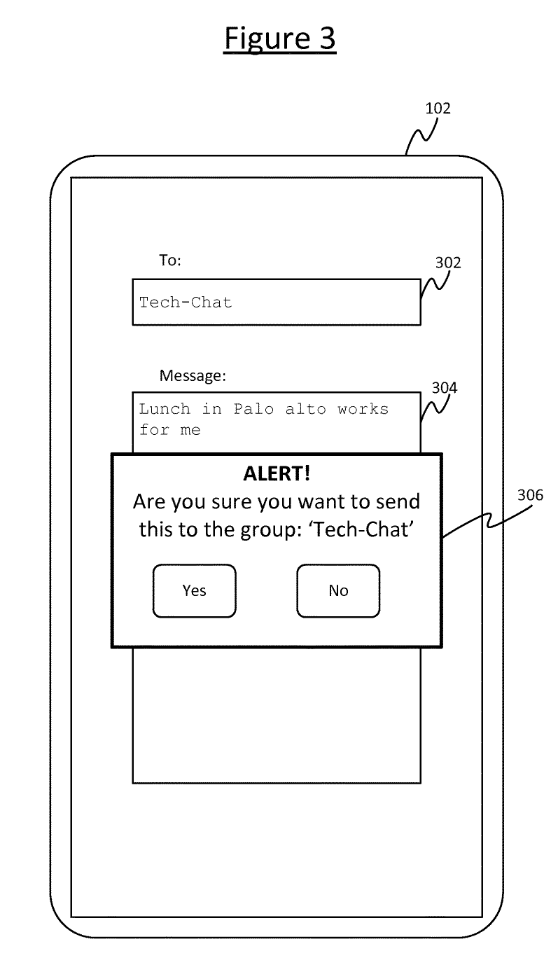

An illustrative example is described in relation to FIG. 3. Consider user X who is a member of two chat rooms: technical one and social one. The recent history of the chats may be as follows:

Technical chat room:
a. Y: What are your results using boosted decision trees?
b. X: Not sure, we only tried SVM and logistic regression.
c. Y: I wonder how boosted trees perform.

Social chat room:
a. X: hey guys, who wants to grab lunch outside tomorrow?
b. Y: we can maybe go to Palo Alto downtown, Mountain View or Los Altos?
c. Y: which one do you prefer?

Consider user X composing a message “Lunch in Palo Alto works for me”. Suppose in the rush of the work day, the technical chat is currently open on user X′s chat application, and the user ends up posting the lunch negotiation message there, by mistake.

If the user was aided by a dedicated and alert human assistant, one can expect the assistant to realize that the message does not really belong to the technical chat, but rather to the social one. Intuitively, we can expect an automated system to realize the mistake as well, at least in some instances, for example by comparing keywords (e.g. “Lunch” and/or “Palo Alto” is mentioned in the social chat and not the technical one, at least recently).

This is illustrated in FIG. 3. The client application 204, through the user interface 202 on the sending user terminal 102a, displays a first field 302 in which the sending user inputs a channel (in the case the name of a chat room), and a second field 304 where the sending user inputs the message itself (the message content). In the first field 302 the sending user has input a response to the lunch conversation intended for the social chat room, but in the second field 304 the specified destination is the technology chat room. In response to detecting that this seems unlikely to be an intended combination, the algorithm 212 sends an alert signal to the communication client 204, in response to which the client outputs an on-screen warning 306 through the user interface 202. The warning 306 gives the sending user the option to either prevent or go ahead with the sending.

In the following are described further details for computing classification probabilities using machine learning in accordance with one or more implementations. The following examples will employ a binary classification method.

In machine learning classification, there are two key components that define its application to a specific domain:

Definition of features containing sufficient predictive power with respect to the classification task

Definition of a way to assemble large training set of labeled examples, i.e. the “ground truth”.

Both approaches are discussed below and in embodiments both are used to implement the machine learning algorithm 212.

The training involves three aspects: individual training examples, a training set and a learning model. A training example, in the sense of binary classification, may be defined as a tuple of message M, author A, and the state of channel C at the time of posting the message. By state of the channel is understand the combination of all messages that were posted to this channel before and its current audience. If this given message M was actually posted to channel C, it constitutes a positive example (labeled as true), otherwise it constitutes a negative example (labeled as false). For each example a number of features are defined, in a standard machine learning sense. These are numbers that convey comprehensive information about the example.

The training set is based on all the prior messages recorded in the communication system (preferably all the past messages of multiple users, not just those of the particular sending user for whom a prediction is currently being made). For a given message M, it go through all the channels C where M was actually posted to. A positive example is defined for each such C, containing the message M, its author A and the state of C at the time of posting, this example is labelled as true. Thus a feature vector is derived for every one of the labelled examples. In embodiments, for all the remaining channels C′, where the message M was not posted, a negative example may be defined for each of them, containing the message M, it's author A and the state of channel C′ at the time of posting, labeled as false. That is, the training data set may also include false examples, wherein each of the false examples comprises, for a respective one of the past messages, an example of a channel to which that message was not sent. These may for example be generated randomly. I.e. for any given message M that was sent to channel(s) C, some other channels C′ is selected randomly from the set of all observed channels, where the message was not sent. This then constitutes a negative example (labelled as “false”).

Regarding the learning model, the list of feature vectors with the binary labels may be fed into to any standard machine learning algorithm for binary classification. There is a number of choices including logistic regression, boosted decision trees and support vector machines. The output is a model which provides a prediction function that can take any new message M, its author A and any candidate channel C (in a state at the time of posting the message M) and produce an estimate of the probability of M belonging to C. The choice of particular machine learning algorithm for binary classification is not essential, and a number of different machine learning algorithms are in themselves known in the art.

Some more details of the features that may be used in the model are now discussed. In embodiments a training example, whether positive or negative, contains a number of elements, roughly structured as follows:

text of the message

author

state of the channel at the time of posting, which in turns breaks into:

history of messages posted there so far (including text, timestamp and other metadata of each message)

audience (other users who would read the message if it was posted into that channel),

time of posting

This provides a wealth of information of mostly qualitative nature, that may yield a variety of patterns. The following features attempt to describe the information in a quantitative manner.

A first category of features that may be included in the feature vector according to embodiments of the present disclosure are features relating the message to channel history.

One motivation for this was shown in the illustrative example above. This shows a situation where a user may be writing a reply to someone else's message in chat (channel) X, but by mistake addressing it to chat (channel) Y. Chances are that the message shares terms (words) with the message (or a couple of messages constituting the temporary focus of discussion) in chat X. Moreover, there may be several topics discussed in channel X, at earlier times, not only at the latest moment.

These features are about text similarity between the message (treated as a text document) and the history of messages posted to the channel (treated as another, bigger document, by concatenating all the messages it was assigned to). If the message document and the channel history document are represented as a bag of words (the skilled person will be familiar with the “bag of words” model) then one can use a number of well know methods for deriving the quantitative similarity between the two, for example:

Cosine similarity,

tf-idf similarity,

Latent Semantic Indexing (LSI), or

A distributed representation such as Deep Structured Semantic Models (DSSM) or word2vec.

These methods differ in complexity. Cosine similarity and tf-idf are the simplest and semantic methods (such as LSI, DSSM) are complex, with implications on resulting efficiency of computation and ease of implementation. Semantic methods strive to unlock semantic features in the text, for example by recognizing equivalence of synonyms that would be otherwise considered as not matching. There are many pros and cons for the choice of the text similarity method, which are generally known and widely studied. However, the choice of particular text similarity algorithm is not material.

Whatever similarity metric is chosen, the parameters (features) of the feature vector may thus comprise a measure of similarity between the respective message and a concatenation of the earlier messages in the channel history within a predetermined time window prior to the respective message (preferably including the earlier messages of all users recorded as having sent to the channel in that time window). E.g. one of the elements of the feature vector may comprise a cosine similarity (or such like) between the body of the respective message and a concatenation of the earlier messages in the history from the preceding hour, or preceding day, or such like.

Further features of the feature vector may comprise temporal aspects. If the full message history was to be used to measure the similarity, the temporal effects of communication would not have been represented fully. For example, in chat communication people typically send messages addressing other recent messages sent by other users. Occasionally they also address older messages, especially when there are several topics being discussed concurrently in the chat. Moreover, certain terms may be characteristic of the overall chat purpose, and they can be scattered arbitrarily in the history of the chat.

Therefore in embodiments the text similarity feature is split into several features defined by the similarity of the message to fragments of the history spread across time. This can be done in variety of ways, for example as follows.

Contiguous samples of the history from the latest message back in time, until certain number of messages or certain amount of time. For example: last message, last 10 messages, last 100 messages etc. Or: last hour, last day, last month of message history, etc.

Contiguous samples of the history with both start and end moving back in time. For example, last 10 messages, messages from 11th to 20th, messages from 20th to 30th, etc. Or: last day worth of messages, a day before that, another day before that, etc.

These ways can also be combined, defined by variety of intervals (time windows) to sample with. It may not be known a priori which fragments of history are more important than others, therefore in embodiments many of them are included in the feature vector.

Thus, the parameters (features) of the feature vector may comprise a set of different instances of the measure of similarity, each being a measure of similarity between the respective message and a concatenation of the earlier messages in the training data set sent to the respective channel within a different time window prior to the respective message.

Another category of features that may be included in the feature vector according to embodiments of the present disclosure are features describing the sending user's history in the channel.

One motivation for this is to try to capture the patterns of users' behaviour with respect to his/her own prior communication in a given channel, such as its intensity and/or vocabulary. For instance these may include one or both of the following.

Count of messages—how many messages the author already posted to the channel. This may be normalized by dividing by all user's messages across all channels.

One or more features relating the respective message to the history of the sending user's prior posts to the channel. Here, the same approach may be used as for the features relating the message to the history of all messages as described above, but applied specifically on a per user basis (only to messages sent by a particular sending user). I.e., a text similarity may be measured between the message and fragments of the particular user's history on the channel spread across time.

Another category of features that may be included in the feature vector according to embodiments of the present disclosure are features describing the audience of the channel.

One motivation for this is to capture the patterns of the sending user's differentiated behaviour (in terms of what and how he communicates) depending on the audience, its size and composition. For example, one typically is reserved when addressing a manager, or his manager, while being relaxed and causal when addressing buddies in a social context. Examples of such features include the following.

i. Size of the audience (number of users that can read the message at the time of posting)

ii. Average number of posts per day

iii. ln a team or enterprise setting, if organizational information is available, features may be included that relate the author to the audience with respect to the organization structure. The specific examples of such features are:

The fraction of author's team members that are in the channel audience

The fraction of author's management chain in the audience

The mean and variance of the organizational depth and organizational depth difference of the audience members.

Yet another category of features that may be included in the feature vector according to embodiments of the present disclosure are features describing time of posting (time of sending).

A motivation for this is to try to capture the patterns of user's behaviour at different times of the day, week, month and/or year. For example, the following Boolean valued features may apply in an enterprise setting:
Is the message posted during working hours?
Is the message posted late at night?
Is the message posted on a week day?

In embodiments, additional metadata available in the channel may be leveraged. Specific communication systems may employ additional metadata associated with the channel. For example, a chat room may be assigned a title, or some keywords or categories, selected by the room owner, to reflect the focus and interest of the discussion in that chat room. These additional elements can be rolled into the present method, by defining additional features. For example, the owner assigned title or keywords of the channel and yield a feature of text between the title words (or keywords) and the text of new message.

A further optional addition to the above techniques is to improve the accuracy of the model with the help of human editors. So far the disclosure has described a fully automated system that learns and predicts without human intervention. This can be extended by adding higher quality training sets produced by human editors. In this arrangement one may envision that a new message (generated by another human user, or perhaps generated by the system) is presented to the editor without any hint of the channel(s) selected for this message. The task of the editor would be to classify this message by hand, and pick the most appropriate channel(s). This procedure will not only produce a high quality training set, but can also serve to test the predictions of the model.

In addition, the fully automated arrangement assumes there is already enough data in the system to produce the training set. Human editor arrangement may address a green field scenario where the system without any history.

### Further Applications, Variations & Extensions

The above has described generally a method of predicting the destination of a message in terms of a channel, where the channel could be a chat room, forum, tag, destination address or individual person. In an application to predicting recipients for communications or collaborations between users, it may be desirable specifically to predict the individual person (or people) to whom a communication is to be directed.

Further, the following describes an application where the message comprises an invitation to a (two-way) communication session that has not occurred yet at the time of sending the invitation. In this case the content of the session is not available to be used for prediction, and instead the training must rely on other features such as the identities of the users, time of sending, relationships between users, etc.

The following may be based upon a similar system to that described above, but used to predict recipients for one or two way communications or collaborations, and in embodiments to predict the destination for invitations to communication sessions that have yet to begin (based on little or no user generated content given that the content of the session is yet to be created). Note that in case of a two way communication such as an audio call or video call, the “recipient” herein refers to the far-end user or invitee (the user on the other end of the session, or invited to a meeting by, the near-end user who is instigating the session or meeting).

The idea is to use a machine-learned model with a large number of input features to predict the probability that a user will contact or collaborate with another user, given the historical context of the users' communications, and the current context of the user. Machine learning is used to train a model that combines the values of the input features and is trained on a large corpus of user communication and collaboration history to account for non-linear relations among features and to avoid over-fitting. In this discussion, let userA be the user the prediction is being made on behalf of, and let userB represent a candidate user for whom is to be estimated the probability that userA will collaborate.

With regard to feature extraction, there are a large number of potential features that can be seen have some predictive power with respect to the problem at hand. The following considers general categories of input features for collaboration prediction and use machine-learning to fit a model to combine these features.

The first category is collaboration history, which is based on the recency and frequency of collaboration between the users and the overall frequency of collaboration events observed for users. For example, the collaboration history may comprise the number, or fraction of, interactions, calls, messages, shared meetings, etc., that userA had with userB over various time periods (for example in the last 7 days, 30 days, or over the entire available collaboration history). These features may also have variants which take into account the directionality of the collaboration, for example whether userA or userB initiated the interaction.

The second category is relationship features, which are based on the relationship between the users. For example, are the users married to one another, are they siblings of one another, do they share a parent/child relationship, or are they related in some other way, etc. For work scenarios, are the users in the same team or workgroup, do they work in the same location, have similar job titles or departments, is one of the users in the others management chain, at similar levels in the organization, etc.

The third category is context features. These features take into account additional context like the user's location, the time of day/week/year, the degree of similarity with existing textual content (like email or meeting subject line, current and/or recent chat messages, whether the interaction is occurring on mobile device, whether the user is at work, home, or some other place, the degree of similarity between the current list of people (in the current meeting, on the current recipient or attendee list) and the lists of people collaborated with in the past.

The fourth category is derivative features. There are derived from applying some function to a feature, or from the combination of features from other categories, for example by taking the log, square root, or square of its value, or by multiplying two or more feature value together. These feature may model some non-linear relationships of feature, or provide a better fit to the distribution of feature values.

The following are examples of collaboration history features, which in embodiments these may be calculated per time interval (e.g. last 5, 30, 90, 3600 days).
i. Attendees—The fraction of meetings userA had with userB in the specified time interval
ii. Attendees Organized A—The fraction of meetings organized by userA where userB was invited in the specified time interval
iii. Attendees Organized B—The Fraction of meetings organized by userB where userA was invited in the specified time interval
iv. Conversations—The fraction of calls and chats userA had with userB in the specified time interval
v. Conversations P2P—The fraction of person-to-person calls or chats userA had with userB in the specified time interval
vi. Conversations Conference—The fraction of conference calls or chats userA had with userB in the specified time interval
vii. Conversation Chats—The fraction of chats userA had with userB in the specified time interval
viii. Conversation Chats P2P—The fraction of person-to-person chats userA had with userB in the specified time interval
ix. Conversation Chats P2P Msgs—The fraction of person-to-person messages exchanged between userA and userB in the specified time interval
x. Conversation Calls—The fraction of calls that userA had with userB in the specified time interval
xi. Conversation Calls P2P—The fraction of person-to-person calls between userA and userB in the specified time interval
xii. Conversation Calls P2P Duration—The fraction of time spent in person-to-person calls between userA and userB in the specified time interval
xiii. Conversation Calls Conference—The fraction of conference calls between userA and userB in the specified time interval
xiv. Conversation Calls Conference Duration—The fraction of time spent in conference calls between userA and userB in the specified time interval
xv. Conversations Initiated—The fraction of calls or chats initiated by userA where userB was a participant in the specified time interval
xvi. Conversation Chats Initiated—The fraction of chats initiated by userA where userB was a participant in the specified time interval
xvii. Conversation Calls Initiated—The fraction of calls initiated by user A where userB was a participant in the specified time interval
xviii. Conversation Calls Initiated Duration—The Fraction of time spent in calls initiated by userA where userB was a participant.

The following are examples of relationship features which may be used to capture the organizational relationship of users.
i. Org Distance—The distance between userA and userB in the org chart
ii. Has Same Site—Whether userA and userB work at the same site
iii. Department Similarity—The degree of similarity between the departments that userA and userB belong to
iv. Title Similarity—The degree of similarity between the job titles of userA and userB
v. Org Depth A—The depth of user A in the org chart
vi. Org Depth B—The depth of userB in the org chart
vii. Org Depth Diff—The difference between the depth of userA and userB in the org chart
viii. Org Depth DiffAbs—The absolute value of the difference between the depth of userA and userB in the org chart
ix. Is Manager A—Whether userA is the manager of userB
x. Is Manager B—Whether userB is the manager of userA
xi. In Management Chain A—Whether userA is in the management chain of userB
xii. In Management Chain B—Whether userB is in the management chain of userA

The following are examples of context-related features which may be used capture the similarity between the context of the prediction and the historical context of the users' collaborations.

Meeting Subject Term Similarity—The degree of similarity between the context terms and the terms in the subject line of meetings that userA had with userB

Conversation Term Similarity—The degree of similarity between the context terms and the terms used in conversations between userA and userB

Meeting People Similarity—The degree of similarity between the list of people in the prediction context to the lists of people that userA and userB were observed to jointly have meetings with

Conversation People Similarity—The degree of similarity between the list of people in the prediction context to the lists of people that userA and userB were observed to jointly have conversations with

The following now describes some examples of training machine learned models for collaboration prediction. Embodiments use supervised learning to train a model to combine the input feature values and compute the probability of collaboration between users. A number of distinct models may be trained each using the same input features, but combining the feature in different ways in order to predict specific kinds of collaboration.

For example, models may be used for a number of prediction tasks:
Call from userA to userB
A call occurring between userA and userB
Chat message sent from userA to userB
Chat message exchange between userA and userB
Meeting invitation sent from userA to userB
UserA and userB invited to the same meeting
UserA initiated a call or chat with userB
UserA initiating call, chat or meeting with userB

Training data is generated from the historical communication/collaboration logs of users. E.g. an initial model may be been trained using approximately 50 years of conversation and meeting history from approximately 30 volunteer users. This may be referred to as the training corpus. The current training corpus contains an entry for each call, instant message and meeting occurring in each volunteer user's exchange mailbox over some time period (e.g. 6 months to several years).

For each call made, instant message sent, and meeting invitation, positive training examples can be created containing the userA (the person who made the call, sent the instant message or meeting invitation), userB (the user receiving the call, message, or invitation), and the feature values (computed between user A and user B) at the creation time of the event. For example, if creating a training example from an instant message sent from userA to userB on Apr. 1, 2014, then the feature values are computed with respect to that date, and aggregated at the configured intervals up to that date.

For each of these positive training examples, a number of negative examples can also be created, where the userB is some user that was not the actual recipient of the call, message, or meeting invitation. This user could be selected randomly from a uniform distribution of candidate users, or selected from a distribution that is skewed toward people that userA has collaborated with more frequently.

A number of parameters may be used to control how negative examples are sampled, how features are normalized or combined, and which features should be used for training.

The labelled training set is then used as input to a machine learning toolkit (e.g. MS internal tool TLC) where many different models and configurations can be evaluated.

A note on preserving privacy: it is possible to preserve the privacy of users in the training corpus by obfuscating user identities. To compute feature values from the training corpus, it is not necessary to obtain the actual identity of the users, and thus user IDs can be replaced with hashed values on import. In this way, the raw data that is used to generate the training corpus contains for example, entries that capture: <hashed_user_from> <hashed_user_to> <event_id> <event_duration>.

Regarding the selection of models; for each prediction task, a wide variety of models are trained and tested using different model parameters, permutations and variations of training data, and subsets of input features. A portion of the training data may be reserved for model evaluation, called the validation set, and not used in the training process. In this case, each model is evaluated using the validation set and a number of metrics are computed including precision, recall, f measure, area under the precision recall curve, etc. The most effective model is then selected based on these metrics. For instance, excellent prediction accuracy may be obtained using logistic regression and gradient boosted decision trees.

Collaboration Index: in order to efficiently compute input features, both for the generation of training set and for online predictions after the model is deployed, an index may be used to store collaboration statistics by day. When computing a feature vector, the index allows the collaboration stats between userA and userB to be quickly retrieved for the desired time interval. The values in the time window are then aggregated as appropriate.

A collaboration predictor may also be used. This is the runtime component that loads models (that were previously trained offline from obfuscated training corpus) and makes predictions for some given userA, given some context including dateTime, text terms, and person list, and set of candidate users. For each userB in the candidate user set, the collaboration stats are for the userA-userB pair are retrieved from the collaboration index. These stats are combined with the context variables to compute the feature values and then fed to the desired model. The model produces a prediction probability for each userB. These results are then sorted in descending order by prediction probability. A threshold may be applied so that only top-k above some threshold probability are displayed.

Some use cases for collaboration prediction are now discussed in more detail.

A first example is people search ranking. In an applications where there is an input element in which people are to be specified, collaboration prediction can be used for ordering search results, or as an input to some other ranking function. For example, in a meeting creation form where the invitees are to be specified, a user may begin by typing the name or email address of the desired user. First a search for matching users can be made, then the matching users are used as the candidates for the collaboration predictor model applied to a meeting invitation task. Similarly, the appropriate corresponding models can be used in call, chat, and email clients' people input elements.

A second example is auto favorites. In communication and collaboration clients, where groups or contact lists are used, the list of the top-k most likely contacts for collaboration can be displayed provided quick shortcuts to the most likely contacts based on the user task and context.

A third example is recommended people. Given some specific collaboration context, like a meeting with some list of invitees and subject text, the most likely additional invitees can be suggested for quick access.

A fourth example is prioritization of inbound communications and notifications. When incoming messages and notifications are received and/or queued, they may be ordered or filtered based on the collaboration prediction probability as an enhancement to existing mechanisms of email clutter detection and inbox prioritization.

Generally the prediction can be used for anything from warning as to possible errors in selected recipients, to providing automated suggestions, to a fully automated selection; as discussed previously in relation to channels. E.g. the generating of the prediction may comprise determining an estimated probability that each of the suggested recipients is intended by the sending user, and outputting the estimated probabilities to the user in association with the suggested recipients (so the user can select from the list of suggestions, informed by the estimated probabilities).

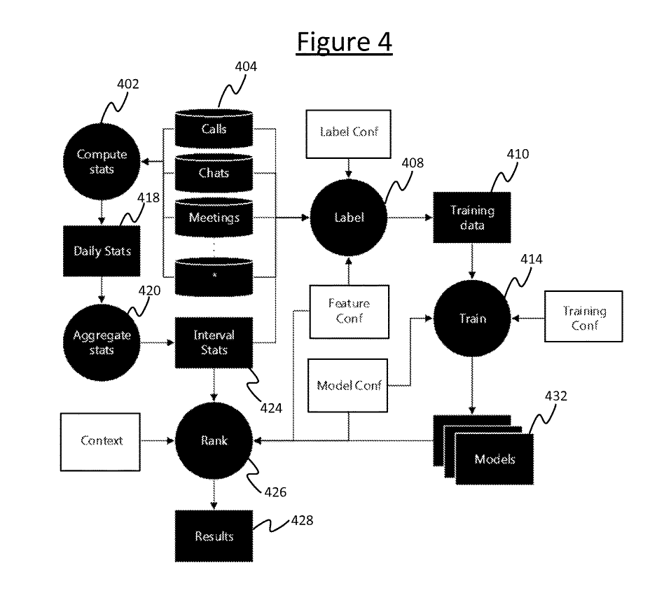

Some further implementation details and examples are now discussed in relation to FIGS. 4 to 9.

The disclosed system is based on a recognition that historical data from collaborations and organizational relationships have tremendous predictive power. Workloads from a variety of communication and collaboration applications contain extremely valuable collaboration data. This data can be used to develop predictive models that dramatically improve the quality of people ranking and recommendation for a variety of workloads and prediction tasks.

The basic machine learning approach may be implemented as follows. Collaboration data is collected to use for supervised machine learning (e.g. meetings from a calendar or appointment application, calls from a VoIP application, conversations from an IM application). From these, features are extracted that are thought to have significant predictive power. For instance these features may comprise, or be based on: recent and/or frequent interactions (e.g. meetings, calls, and/or chats); organizational relationships (e.g. reporting chain, job title, department, and/or location); and/or contextual similarity (e.g. participant list, text terms, temporal, spatial). This collaboration data is used to generate labelled training data. For instance calendar and conversation history may contain ground truth about collaborations (e.g. personA invited personB to a meeting with some subject and participant list. By using labelled training data to create machine learned models, models can be trained for a variety of prediction tasks (e.g. predict attendees of meetings, participants of calls and chats). This enables the making of runtime predictions using the current tasks' context (e.g. subject line, participant list), the user collaboration history, and machine learned models.

FIG. 4 gives a schematic block diagram of a machine learning pipeline in accordance with embodiments disclosed herein. Collaboration data 404, including meetings and conversations, are periodically retrieved, encrypted and stored securely. The collaboration statistics 404 are computed 402 from the user data and stored per user, per day. Daily statistics 418 are temporally aggregated 420 based on configured time intervals, (e.g. last 5, 30, 90, 3600 days). Raw collaboration data+ interval stats 424 are used to create 408 labelled training data 410, to train 414 models 432 for specific tasks like predicting participants of meeting, call, and chats. A ranker 426 imports the machine-learned models 432 for specific prediction tasks. The ranker 426 makes ranked predictions 428 for users based on their intervals stats 424 and specific collaboration context.

Prediction tasks may for example comprise: meetings attendee prediction (who will you invite to a meeting?), call participant prediction (who will you call?), what participant prediction (who will you instant message?), conversation prediction (who will you call or instant message?), and/or collaboration prediction (who will you invite to a meeting, call, or IM?). The goal is to make ranked predictions based on current context, e.g. the specified prediction task (meeting, call, chat, . . . ); terms in the subject line or body of the current meeting or conversation; and/or current list of people in the meeting invite or conversation group.

In embodiments there may be any one or more of four main categories of features used to make predictions: (i) collaboration counts (features based on counts of user-user collaboration events for specified time intervals, e.g. including meetings, calls, chats); (ii) text term similarity (features representing the degree of similarity between text in the prediction context, and the text that occurs in collaboration between users); (iii) people similarity (features representing the degree of similarity between the current list of participants in the prediction context and the list of participants in the users collaboration history); and/or (iv) organizational relationships (features representing the organizational relationship between users).

Collaboration features are computed for a particular user, userA, with respect to a candidate user, userB, for various time intervals. With regard to the text term similarity feature category, when the prediction context contains text terms, for example a subject line, or chat terms, then the text term similarity feature represents the degree of similarity of those terms to terms in the user collaboration history. With regard to the people similarity feature category, when the prediction context contains a list of one or more people, then the people similarity represents the similarity of the list to the list of people observed in the user collaboration history. With regard to the organizational feature category, when userA and userB are both in the same company directory, then the Org feature category represents the org relationship of the users. Note that the text term similarity feature category and the people similarity feature category may be considered together as one larger context category.

To generate training data, each item in users' collaboration history can be used as ground truth. Meeting and conversations initiated by each user can be used to generate positive and negative training examples. Meeting and conversation data from many users are combined into one large collaboration dataset. A positive example is created for each participant of each meeting or conversation organized or initiated by each user in the collaboration dataset. Various permutations of text terms and participants are used to generate multiple examples per collaboration item. A sample of people in the organization, but not in the participant/attendee list of the item, are used to generate negative examples.

An example meeting from collaboration history:

| | |
|---|---|
| { | |
| a. | subject: “Machine learning”, |
| b. | organizer: “dracz@microsoft.com”, |
| c. | participants: [ |
| d. | “jkorycki@microsoft.com”, |
| | “kavitak@microsoft.com”], |
| e. | timestamp: “2014-10-31 12:00:00-8:00”, |
| f. | ... |
| } | |

Various permutations of positive (label=1) and negative examples (label=0) can be generated. Conf parameters are used to control labelling options and permutations. An example set of training data would be:

| userB | Label | Subject | participants |
|---|---|---|---|
| jkorycki | 1 | Machine Learning | kavitak |
| jkorycki | 1 | Machine | kavitak |
| jkorycki | 1 | | kavitak |
| jkorycki | 1 | Machine Learning | |
| jkorycki | 1 | Machine | |
| kavitak | 1 | Machine Learning | jkorycki |
| kavitak | 1 | Machine | jkorycki |
| kavitak | 1 | | jkorycki |
| kavitak | 1 | Machine Learning | |
| kavitak | 1 | Machine | |
| bimalm | 0 | Machine Learning | kavitak, jkorycki |
| bimalm | 0 | Machine | kavitak, jkorycki |
| bimalm | 0 | | kavitak, jkorycki |
| bimalm | 0 | Machine Learning | kavitak |
| bimalm | 0 | Machine | kavitak |
| bimalm | 0 | | kavitak |
| bimalm | 0 | Machine Learning | jkorycki |
| bimalm | 0 | Machine | jkorycki |
| bimalm | 0 | | jkorycki |
| weihua | 0 | Machine Learning | kavitak, jkorycki |
| weihua | 0 | Machine | kavitak, jkorycki |
| weihua | 0 | | kavitak, jkorycki |
| . . . | | | |

Regarding training model, any of a variety of models may be used for collaboration prediction and person ranking, such as: supervised models (using TLC), gradient-boosted decision trees, logistic regression, support vector machines, heuristic (handmade rules), and/or Bayesian (e.g. using Internet). E.g. one embodiment uses logistic regression models.

Here are some example results obtained using logistic regression, for a task of collaboration prediction, based on 2-fold cross validation; ˜50 features; 5, 30, 90, 3600 day intervals; and ˜200k training instances.

| | Predicted Positive | Predicted Negative | Recall |
|---|---|---|---|
| Truth | 14590 | 5095 | 0.7412 |
| Positive | | | (14590/19685) |
| Truth | 1052 | 195709 | 0.9947 |
| Negative | | | (195709/196761) |
| Precision | 0.9327 | 0.9746 | |
| | (14590/15642) | (195709/200804) | |

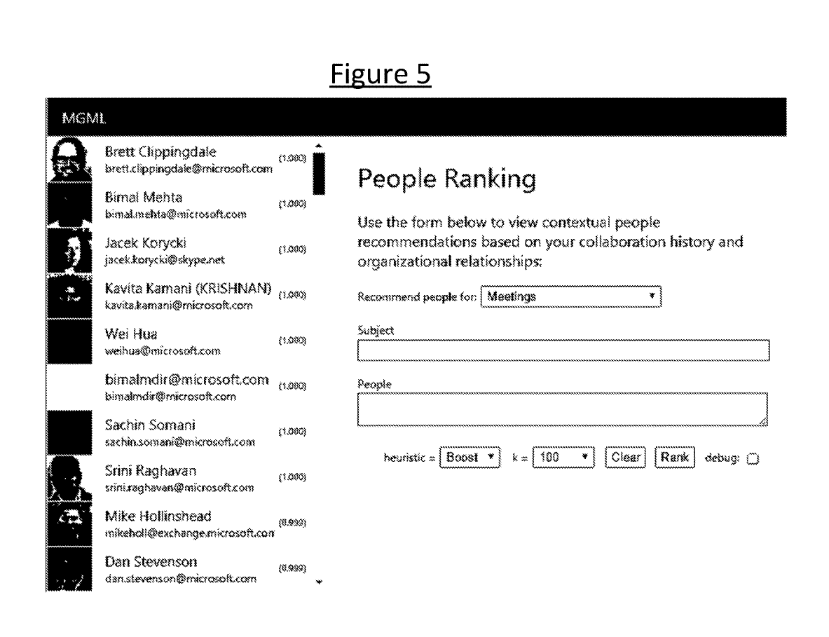

FIGS. 5 to 9 show some mocked up screen shots of an application using collaboration prediction in accordance with embodiments disclosed herein.

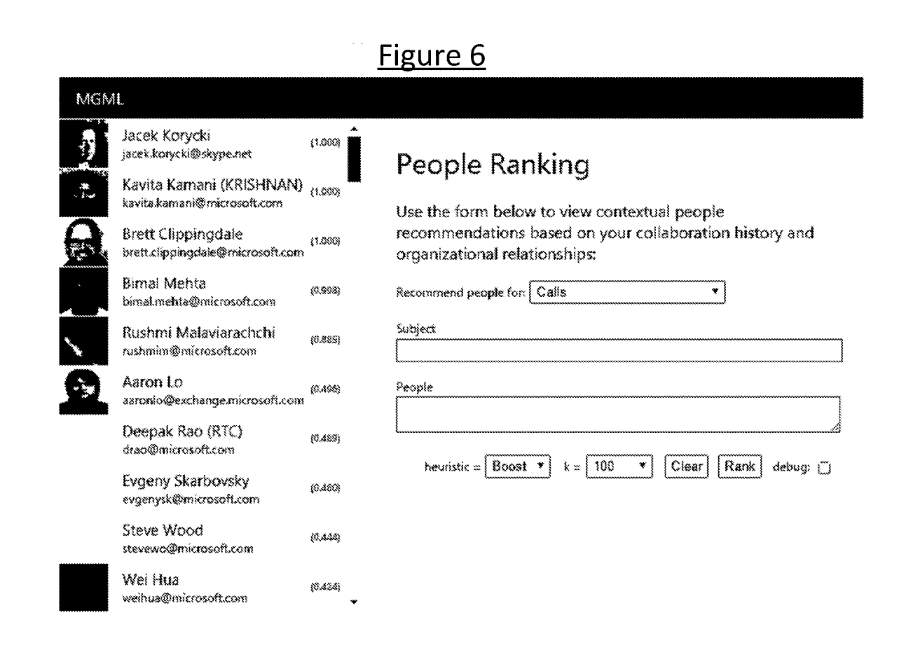

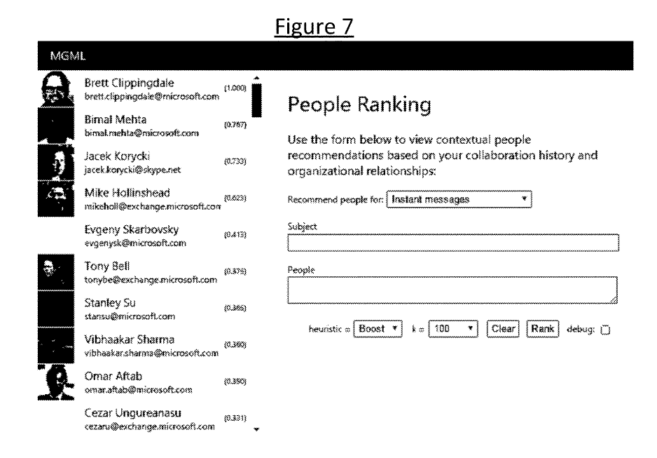

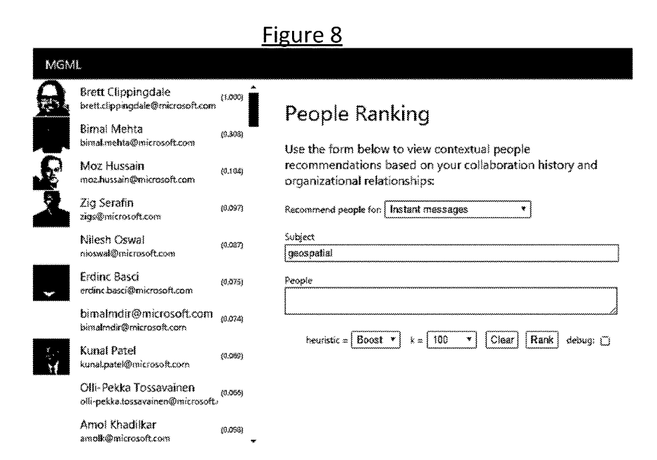

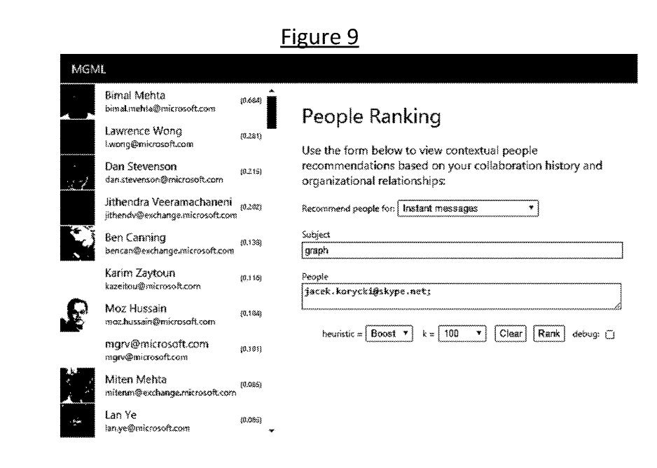

FIG. 5 is an example of predicting most likely people for meetings. A recommend people drop-down is used to select the prediction task. FIG. 6 shows an example of predict most likely people to be called. A recommend people drop-down is used to select the prediction task. FIG. 7 shows an example of predicting most likely Instant message recipients based on context keyword. FIGS. 8-9 show an example of predicting most likely instant message recipients given context keyword and existing people.

A recommend people drop-down is used to select the prediction task. The left-hand pane shows the top-k candidates for the prediction given the Subject and People context. Entering some subject text will rank more highly people with whom you have had collaborations containing similar text. Clicking on a result will add that person to the People list. People in the people list provide additional context. People with whom you have together with people in context should rank more highly. People names can be added directly to the people box for auto-suggestions. Checking debug will show the feature values that are used to compute the individual rankings.

It will be appreciated that the above embodiments have been described only by way of example.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals and/or server may also include an entity (e.g. software) that causes hardware of the user terminals to perform operations, e.g., processors functional blocks, and so on. For example, the user terminals and/or server may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals and/or server through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
collecting a training data set describing multiple past communications previously conducted over a computer-implemented communication service, wherein for each respective one of the past communications, the training data set comprises a record of a respective one or more recipients of the respective communication, and a record of a respective feature vector of the respective communication, wherein the each of the recipients is defined in terms of an identity of an individual person with whom the respective communication was conducted, and wherein the feature vector comprises a respective set of values of a plurality of parameters associated with the conducting of the respective communication;
inputting the training data into a machine learning algorithm in order to train the machine learning algorithm; and
by applying the machine learning algorithm to a further feature vector comprising a respective set of values of said parameters for a respective message to be sent by a sending user over the computer-implemented communication service, generating a prediction regarding one or more potential recipients of the message, each of the one or more potential recipients also being defied in terms of an identity of individual person.

2. The method of claim 1, wherein the message is an invitation to a communication session that is yet to take place at the time of sending said message.

3. The method of claim 2, wherein the communication session is an in-person meeting;
and wherein each of some or all of the past communications is a past in-person meeting.

4. The method of claim 2, wherein the communication session is a voice or video call;
and wherein each of some or all of the past communications is a past voice or video call.

5. The method of claim 2, wherein the communication session is an IM chat session;
and wherein each of some or all of the past communications is a past IM chat session.

6. The method of claim 1, wherein each of the feature vectors contains no parameters based on any user-generated content of the message.

7. The method of claim 1, wherein the parameters of each of the feature vectors comprise one or more parameters based on a user-generated title or subject line of the past communications.

8. The method of claim 7, wherein each of the feature vectors comprises no parameters based on any user-generated content other than the title or subject line.

9. The method of claim 1, wherein the parameters of each of the feature vectors comprise any one or more of:
an identifier of the sending user,
a time of conducting the respective message,
an amount of previous activity between the sending user and the respective recipient,
a measure of how recently the sending user has communicated with the more respective recipient, and/or
a relationship between the sending user and the respective recipient.

10. The method of claim 1, wherein the identities of the recipients in said record are recorded in a transformed form in order to obscure the identities.

11. The method of claim 1, wherein the one or more potential recipients are one or more target recipients manually selected by the sending user prior to sending said message, and wherein the generating of said prediction comprises determining an estimated probability that each of the target recipients is intended by the sending user, and generating a warning to the sending user if any of the estimated probabilities is below a threshold.

12. The method of claim 1, wherein the one or more potential recipients are one or more suggested recipients, the generating of said prediction comprising generating the suggested recipients and outputting them to the sending user prior to the sending user entering any target recipients for said subsequent message.

13. The method of claim 1, wherein the generating of said prediction comprises determining an estimated probability that each of the suggested recipients is intended by the sending user, and outputting the estimated probabilities to the user in association with the suggested recipients.

14. The method of claim 1, wherein the one or more potential recipients are one or more automatically-applied recipients, the generating of said prediction comprising generating the automatically-applied recipients and sending the message to them without the sending user entering any target recipients for said subsequent message.

15. The method of claim 1, wherein the training data set further includes false examples, each of the false examples comprising, for a respective one of the past communications, an example of a recipient with whom the respective message was not sent.

16. The method of claim 1, wherein the training data set is refined by a human editor.

17. A network element comprising:
a data store storing a training data set describing multiple past communications previously conducted over a computer-implemented communication service, wherein for each respective one of the past communications, the training data set comprises a record of a respective one or more recipients of the respective communication, and a record of respective feature vector of the respective communication, wherein each of the recipients is defined in terms of an identity of an individual person with whom the respective communication was conducted, and wherein the feature vector comprises a respective set of values of a plurality of parameters associated with the conducting of the respective communication; and
a machine learning algorithm arranged to be trained based on the training data set;
wherein based on a further feature vector comprising a respective set of values of said parameters for a respective message, to be sent by a sending user over the computer-implemented communication service, the machine learning algorithm is arranged to generate a prediction regarding one or more potential recipients of said message, each of the potential recipients also being defied in terms of an identity of individual person.

18. The network element of claim 17, wherein the network element is a server arranged to serve a user terminal of the sending user.

19. The network element of claim 17, wherein the network element is a user terminal of the sending user.

20. A computer program product embodied on a computer-readable storage medium and configured so as when run on a processing apparatus comprising one or more processing units to perform operations comprising:
accessing a training data set describing multiple past communications previously conducted over a computer-implemented communication service, wherein for each respective one of the past communications, the training data set comprises a record of a respective one or more recipients of the respective communication, and a record of respective feature vector of the respective communication, wherein each of the recipients is defined in terms of an identity of an individual person with whom the respective communication was conducted, and wherein the feature vector comprises a respective set of values of a plurality of parameters associated with the sending of the respective communication;
inputting the training data into a machine learning algorithm in order to train the machine learning algorithm; and
by applying the machine learning algorithm to a further feature vector comprising a respective set of values of the parameters of a respective message, to be sent by a sending user over the computer-implemented communication service, generating a prediction regarding one or more potential recipients of the message, each of the potential recipients also being defied in terms of an identity of individual person.
